(19) United States
(12) Patent Application Publication
(10) Pub. No.: US 2008/0298288 A1
(43) Pub. Date: Dec. 4, 2008

(54) POWER SAVE MODE FOR WIRELESS STATION WITH STATION-TO-STATION LINK ASSOCIATION

(76) Inventor: Suman Sharma, Beaverton, OR (US)

Correspondence Address: INTEL CORPORATION;c/o INTELLEVATE, LLC, P.O. BOX 52050, MINNEAPOLIS, MN, 55402, US

(21) Appl. No.: 11/757,930

(22) Filed: Jun. 4, 2007

(51) Int. Cl. H04Q 7/00

(52) U.S. Cl. 370/311

(57) ABSTRACT

While maintaining a direct station-to-station link (STSL) with a second wireless client device in a centralized network, a first wireless client device may enter a doze mode, in which it cannot transmit or receive, and wake up periodically only to check for queued-up traffic from its associated access point. If the second wireless device in the STSL has data to send to the dozing first wireless device, it may do so by sending a notice to the first wireless device through the associated access point, which may queue up the notice until the first wireless device wakes up. When the first wireless device receives the notice, it may resume STSL communications with the second wireless device.

### CROSS REFERENCE TO RELATED APPLICATIONS

This patent application is related to patent application Ser. No. 11/799,980, filed on May 3, 2007, and titled “Direct Station-To-Station Link Between Wireless Network Devices”, which has the same inventor and is owned by the same entity.

### BACKGROUND

When two client devices (e.g., mobile devices) in a centralized wireless network establish a direct wireless link with each other, each should constantly listen for incoming transmissions from the other. This prevents either device from going into a power-saving inactive mode, and therefore drains the battery unnecessarily when neither device is communicating with the other.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a diagram of a WLAN network with station-to-station link (STSL) capability, according to an embodiment of the invention.

FIGS. 2A, 2B show a flow diagram of a communications exchange pertaining to a doze mode during an STSL session, according to an embodiment of the invention.

FIG. 3 shows a diagram of an STSL frame, according to an embodiment of the invention.

FIGS. 4A, 4B, and 4C show specific types of STSL payloads, according to embodiments of the invention.

FIG. 5 shows the format of an attempt to send data to a device in a doze mode, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a machine-readable medium, which may be read and executed by one or more processors to enable performance of the operations described herein. A machine-readable medium may include any mechanism for storing, transmitting, and/or receiving information in a form readable by a machine (e.g., a computer). For example, a machine-readable medium may include a storage medium, such as but not limited to read only memory (ROM); random access memory (RAM); magnetic disk storage media; optical storage media; a flash memory device, etc. A machine-readable medium may also include a propagated signal which has been modulated to encode the instructions, such as but not limited to electromagnetic, optical, or acoustical carrier wave signals.

The term “wireless” and its derivatives may be used to describe circuits, devices, systems, methods, techniques, communications channels, etc., that communicate data by using modulated electromagnetic radiation through a non-solid medium. The term does not imply that the associated devices do not contain any wires, although in some embodiments they might not. The term “mobile wireless device” is used to describe a wireless device that may be in motion while it is communicating.

Various embodiments of the invention relate to permitting a first wireless client device, while maintaining a direct station-to-station link (STSL) with a second wireless client device, to enter a power-saving inactive mode while still maintaining the STSL. A request from the second device to resume STSL communications may be routed through an access point, to be received by the first device after the first device wakes up to determine if the access point has data traffic queued up for it. If the access point does have data queued up for the recently-awakened first device, and if that data indicates the second device wishes to resume STSL communications, the first device may initiate such communications over the STSL.

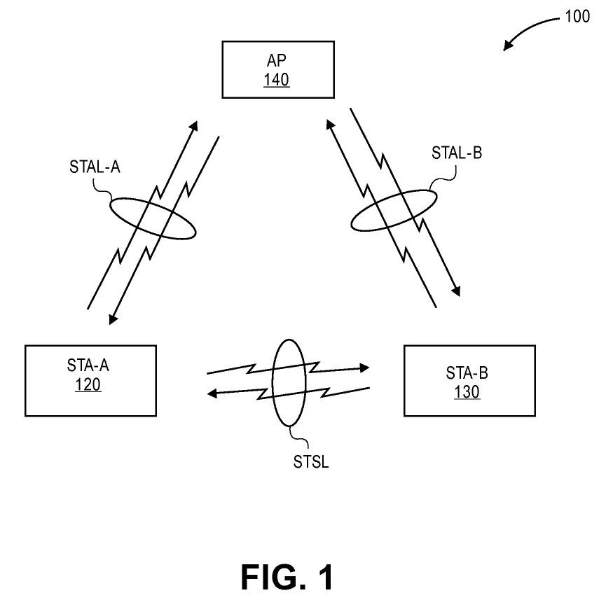

FIG. 1 shows a diagram of a WLAN network with station-to-station link (STSL) capability, according to an embodiment of the invention. Within the context of this document, the term STSL will be used to indicate a wireless communications link directly between two devices, neither of which is an access point, but both of which are communicatively associated with the same access point. This WLAN network may comply with formats, protocols, and restrictions outlined in standard IEEE 802.11-2007, published in 2007 by the Institute of Electrical and Electronic Engineers. In the illustrated network 100, a wireless client device 120 may establish a wireless communications link with an access point (AP) 140. Another wireless client device 130 may similarly establish a wireless communications link with the same AP 140. Other wireless client devices may also be present in the network, but for simplicity of illustration they are not shown. Each wireless client device is labeled as a STA, to be consistent with industry terminology, with device 120 labeled as STA-A and device 130 labeled as STA-B. The wireless link between STA-A and the AP is labeled STAL-A and the wireless link between STA-B and the AP is labeled STAL-B. Each wireless device in FIG. 1 may contain one or more antennas to facilitate the wireless communications.

Normally, STA-A might communicate directly only with the AP, and STA-B might also communicate directly only with the AP, with any communications between STA-A and STA-B being routed through the AP, using conventional techniques. However, STA-A and STA-B may also establish a direct wireless link between themselves, with this station-to-station link labeled as STSL, so that subsequent communications between STA-A and STA-B do not have to be routed through the AP. This STSL may be established by sending the appropriate frames between STA-A and STA-B through the AP, and using the contents of the payload section of these frames to set up the STSL. By using the payload section in this manner, legacy AP's should not have to be modified to set up the STSL. This is an advantage over using the conventional Direct Link Setup (DLS) to establish a direct link.

While in the STSL, at least one of the STAs in the STSL may go into a low-power inactive mode in which it cannot transmit to, or receive from, other wireless devices (this is referred to herein as a ‘doze mode’, although various embodiments of the invention may encompass systems that do not use that term). However, it may awaken at scheduled times to listen for a beacon from the AP that will indicate if the AP has traffic queued up for it. In some embodiments, this beacon may be a Delivery Traffic Indication Message (DTIM) beacon, transmitted at predetermined intervals that are known to the STAs, although other embodiments may use other techniques. If the DTIM beacon does not indicate any queued up data for the STA, the STA may again enter the doze mode until it awakens for another DTIM beacon. However, if the DTIM beacon indicates the AP has data queued up for the newly-awakened STA, then the STA may remain awake to retrieve the data, and if necessary act on that data. In some embodiments, when the STA determines it has queued-up data waiting for it, it may send a short PS-Poll frame to the AP, and the AP may respond by transmitting the queued-up data. The STA may then act on that data in whatever manner is appropriate.

Since direct communications from the other STA in the STSL are not detectable while this STA is in the doze mode, if the other STA wishes to communicate with the dozing STA, it may route a message to the dozing STA through the AP, to be detected when the inactive STA wakes up and receives the next DTIM beacon. This message may contain a notice that data is pending for transmission using STSL. When the recently-awakened STA gets this notice through the AP, it may remain awake to resume communications with the other STA over the STSL.

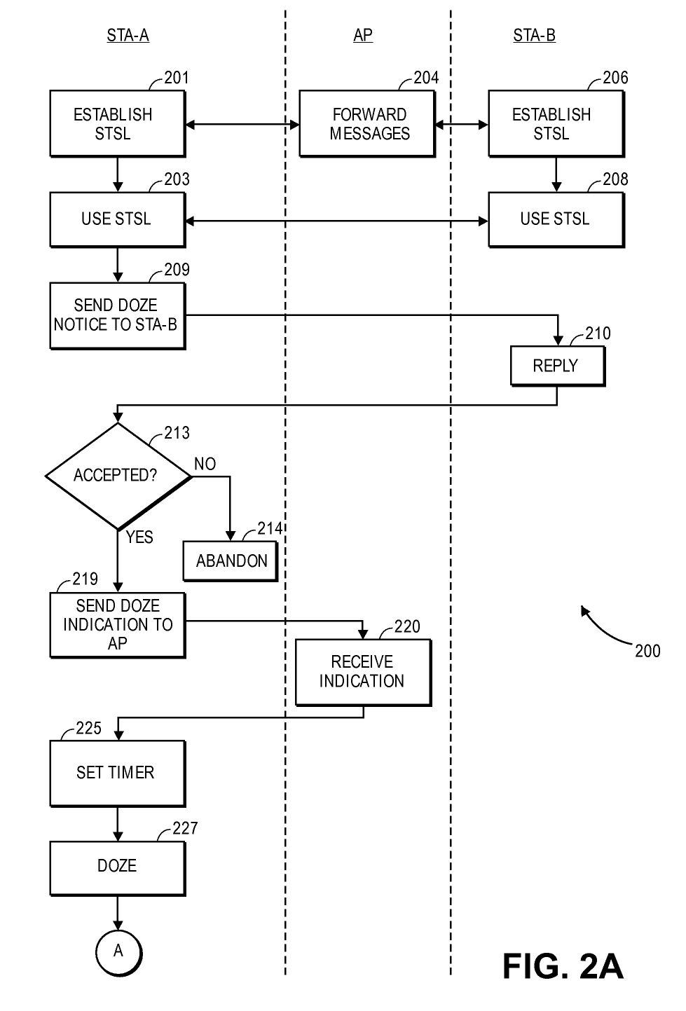

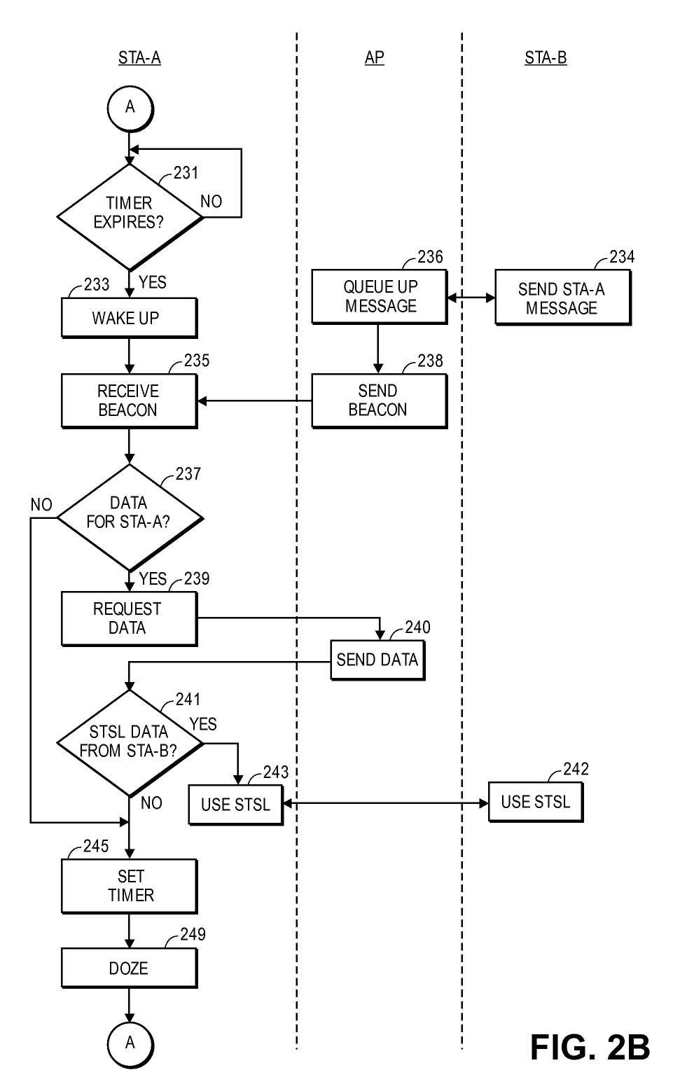

FIGS. 2A, 2B show a flow diagram of a communications exchange pertaining to a doze mode during an STSL session, according to an embodiment of the invention. In the illustrated flow diagram 200, three vertical columns separated by dashed lines indicate the operations performed devices designated STA-A, STA-B, and the associated AP, respectively (see FIG. 1). The process may begin at the top of FIG. 2A when STA-A and STA-B set up an STSL by communicating through the AP (which forwards frames between STA-A and STA-B), as shown at 201, 204, and 206. Once the STSL direct link is set up, STA-A and STA-B may communicate directly with each other at 203 and 208.

In the illustrated example, STA-A wishes to go into a doze mode (i.e., a power saving mode in which STA-A does not transmit or receive wireless data), but does not wish to terminate the STSL association with STA-B. This process may be initiated at 209 when STA-A transmits a notice of its intentions to STA-B over the STSL. STA-B may then reply to this notice at 210. If the reply indicates that the doze notice is rejected by STA-B (e.g., if STA-B has data queued up for immediate STSL transmission to STA-A, or if the length of the intended doze mode is unacceptable), as determined at 213, then at 214 STA-A may abandon its attempt to doze. However, if the reply indicates that STA-B accepts the doze notice, then at 219 STA-A may transmit to the AP an indication that STA-A is about to enter the doze mode and will therefore be unavailable for normal communications with the AP for a while. The AP may receive the indication at 220, and subsequently place in a queue any data traffic it receives for STA-A. STA-A may then set an internal timer for its doze mode at 225, to expire when it is time for STA-A to awaken and listen for the DTIM beacon from the AP. STA-A then enters the doze mode at 227.

Continuing at the top of FIG. 2B, the timer in STA-A may continue to run at 231 until it expires, indicating it is time for STA-A to wake up at 233 and listen for the DTIM beacon from the AP at 235. In the meantime, if STA-B has data to send to STA-A, but knows that STA-A is in a doze mode and cannot receive anything over the STSL, STA-B may address a message to STA-A but route the message through the AP at 234. The AP may then queue up the message at 236 and wait until STA-A indicates it is awake and ready to receive the data. In some operations, this message may be used to indicate that STA-A should use the STSL to get data from STA-B directly. However, in other operations, the data itself may be contained in the message, especially if the data is comparatively short.

When STA-A wakes up at 233 (after expiration of the timer at 231), the AP should be ready to send out a DTIM beacon at 238, indicating whether it has a message queued up for STA-A. If the beacon indicates that the AP has nothing queued up for STA-A, as determined at 237, then STA-A may set its timer again at 245 and enter the doze mode again at 249, to awaken later for a subsequent DTIM beacon. If STA-A learns from the AP at 237 that the AP has data queued up for STA-A, it may request that data at 239 and the AP may send that data at 240. If this data indicates at 241 that STA-B has STSL communications for STA-A, then STA-A and STA-B may resume using the STSL at 243 and 242 to communicate directly with each other. The entire sequence of FIGS. 2A, 2B may be repeated as often as needed.

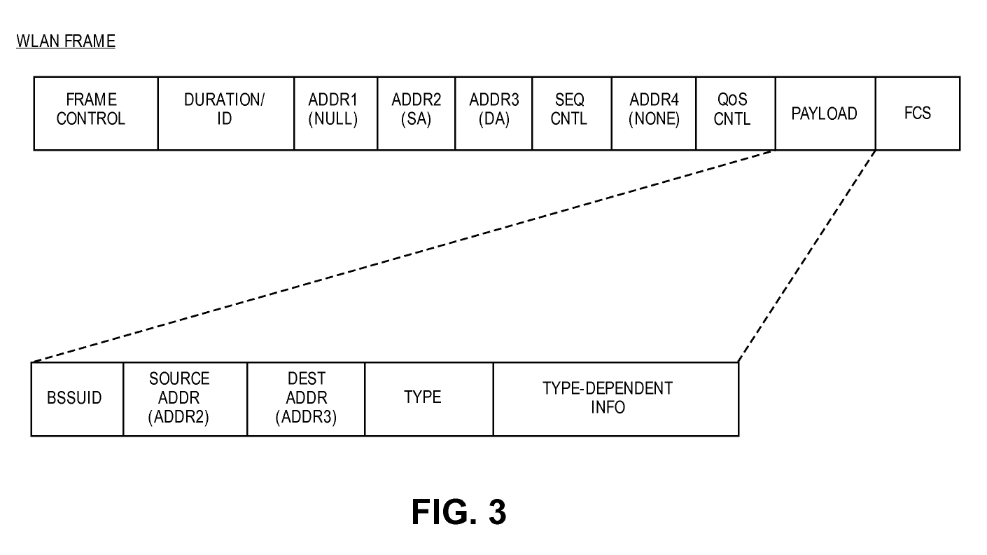

FIG. 3 shows a diagram of an STSL frame used in direct communications between two STAs, according to an embodiment of the invention. Since the frame is passing directly from one STA to another without going through an AP, there may be no need to follow the format used when routing data through an intervening AP. However, the example shown in FIG. 3 uses the same basic format as traffic that goes through an AP, since the processing is already in place to handle that format. Other embodiments may use other formats.

In the example of FIG. 3, the basic format of a WLAN frame is used. The WLAN format may be found in the aforementioned standard IEEE 802.11-2007, but is repeated at the top of FIG. 3 for convenience. In this format, the frame begins with a Frame Control section, which specifies various parameters of the frame, followed by a Duration/ID section, which among other things indicates the length of the frame. This may normally be followed by three addresses. The first address would normally specify the AP, and but contains a null since there is no AP to specify. The second address (ADDR2) is the Source, i.e., the address of the device that is transmitting this frame. The third address (ADDR3) is the Destination address, i.e., the address of the device that is to receive the payload of this frame. In the case of STA-A sending a frame to STA-B, the Source address would indicate STA-A and the Destination address would indicate STA-B.

These addresses may be followed by a Sequence Control section, to help in reconstructing a string of multiple frames that might be received out of order if some of them have to be re-transmitted due to errors in the received signal. A fourth address may optionally follow, but may be unused in this particular implementation. QoS CNTL may be used to indicate that the protocols for Quality of Service communications are being used. This is then followed by the payload section, and then a Frame Checksum section FCS which may be used to detect errors in the received frame (which could in turn result in the aforementioned retransmissions).

An expanded view of the payload section is shown in the bottom part of FIG. 3. The payload may contain information that has been formatted specifically for STSL communications. In this example, a field for basic service set unique identifier (BSSUID) may contain the set of parameters necessary to identify the BSS uniquely. For example, the BSSUID field may contain the BSS ID, the applicable regulatory class, and the channel number. The Source address (SOURCE ADDR) and Destination address (DEST ADDR) may be repeated for processing by STSL-specific code. The TYPE field may indicate what type of STSL data is being conveyed, while the format of the TYPE-DEPENDENT INFO field may vary, depending on the contents of the TYPE field.

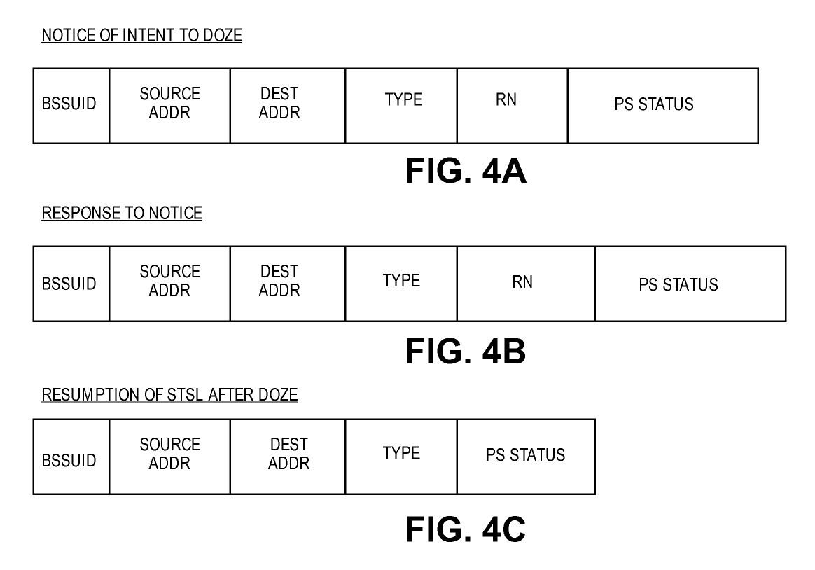

FIGS. 4A and 4B show two specific types of STSL payloads, according to embodiments of the invention. The first four fields (BSSUID, SOURCE ADDR, DEST ADDR, and TYPE) of each of these are as previously described in FIG. 3, while the remaining sub-fields expand on the TYPE-DEPENDENT INFO of FIG. 3.

FIG. 4A shows the format of a notice that one of the devices in the STSL wishes to enter a doze mode. For this example, assume that STA-A wishes to enter a doze mode while it has an STSL established with STA-B. The SOURCE ADDR would indicate STA-A, while the DEST ADDR would indicate STA-B. The RN field may contain a number that will be used to verify any response to this frame. In some embodiments, the number may be generated by a random or pseudo-random number generator in STA-A. This may be followed by a PS STATUS field, which indicates that this frame contains a notice of an intent to enter a doze mode.

FIG. 4B shows the format of a response to the frame of FIG. 4A. In this case, STA-B would be the device originating the response frame (SOURCE ADDR), and STA-A would be the intended recipient of the frame (DEST ADDR). The RN field may repeat the contents of the RN field of the frame of FIG. 4A, to verify this is a legitimate response to that frame. The PS STATUS field may indicate that this is a response to a notice of intent to enter a doze mode, and may further indicate what that response is. If STA-B does not want STA-A to enter the indicated doze mode at this time, it may indicate in the PS STATUS field that it is rejecting that notice. However, if it has no objection to STA-A entering the indicated doze mode, it may indicate acceptance in the PS STATUS field. In the illustrated embodiments, the format of FIG. 4B is the same as that of FIG. 4A, but the contents of the individual fields may differ. However, other embodiments may use different format for the notice and the response.

STA-A may take action based on the contents of the response from STA-B. For example, if the response is a rejection, it may abandon its attempt to enter a doze mode, and may re-attempt a doze mode it at a later time. However, if the response is an acceptance, STA-A may make appropriate notification to its associated AP, and then enter the doze mode.

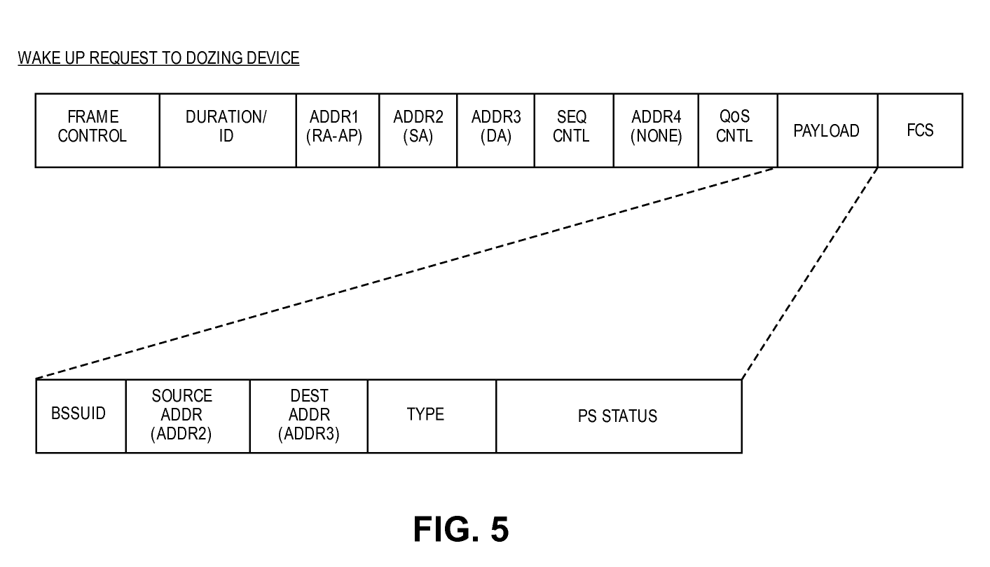

FIG. 5 shows the format of an attempt to send data to a device in a doze mode, according to an embodiment of the invention. If non-dozing STA-B wishes to send data to dozing STA-A, it may send that data through the AP. FIG. 5 shows one example of such a transmission to the AP. The basic frame format may be the same as described for FIG. 3, except that since the frame is being routed through an intermediate AP, ADDR1 may contain the address of the AP rather than containing a null character. SOURCE ADDR would indicate STA-B, while DEST ADDR would indicate STA-A. The PS STATUS field may indicate that this is a request to STA-A such that, when STA-A wakes up, it should resume direct communications with STA-B over the STSL. In some instances for some embodiments (for example, if the data to be sent is short), the data may follow the PS STATUS field in this payload (not shown), eliminating the need to resume the STSL direct communications. The PS STATUS field may have a separate code to indicate this condition. However, if STSL direct communications are to be resumed, when STA-A receives the notice to resume STSL communications, it may sent a notice to STA-B to resume those direct communications.

FIG. 4C shows the format of a frame to resume STSL communications after exiting from a doze mode, according to an embodiment of the invention. After exiting the doze mode and determining that direct communications with STA-B are once again desired, STA-A may send a frame to STA-B, using the overall frame format of FIG. 3 and the payload contents of FIG. 4C. The PS STATUS field of FIG. 4C may indicate resumption of direct STSL communications between STA-A and STA-B. After receiving this frame, STA-B may continue communicating directly with STA-A as it did before STA-A entered a doze mode.

The foregoing description is intended to be illustrative and not limiting. Variations will occur to those of skill in the art. Those variations are intended to be included in the various embodiments of the invention, which are limited only by the spirit and scope of the following claims.

What is claimed is:

1. A method, comprising:
establishing a direct station-to-station communications link (STSL) with another client device in a centralized wireless network, in which STSL communications are established with contents of payloads of one or more frames routed through an access point;
transmitting a notification to the other client device of an intention to enter a doze mode of operation;
receiving a response to the notification from the other client device; and
entering the doze mode of operation if the response contains an acceptance of the notification.

2. The method of claim 1, wherein the notification is included in a payload of a frame transmitted to the other client device.

3. The method of claim 1, wherein the response is included in a payload of a frame received from the other client device.

4. The method of claim 1, further comprising:
waking up from the doze mode to determine if the access point has one or more communications frames queued up; and
receiving the one or more communications frames if they are queued up.

5. The method of claim 4, further comprising:
determining if the one or more communications frames contain a request from the other client device to communicate using the STSL; and
communicating with the other client device using the STSL if the one or more communications frames contain the request.

6. An article comprising
a tangible machine-readable medium that contains instructions, which when executed by one or more processors result in performing operations comprising:
establishing a direct station-to-station communications link (STSL) with another client device in a centralized wireless network, in which STSL communications are established with contents of payloads of one or more frames routed through an access point;
transmitting a notification to the other client device of an intention to enter a doze mode of operation;
receiving a response to the notification from the other client device; and
entering the doze mode of operation if the response contains an acceptance of the notification.

7. The article of claim 6, wherein the operation of transmitting the notification comprises including the notification in a payload of a frame transmitted to the other client device.

8. The article of claim 6, wherein the operation of receiving the response comprises receiving the response in a payload of a frame received from the other client device.

9. The article of claim 6, wherein the operations further comprise:
waking up from the doze mode to determine if the access point has one or more communications frames queued up; and
receiving the one or more communications frames if they are queued up.

10. The article of claim 9, wherein the operations further comprise:
determining if the one or more communications frames contain a request from the other client device to communicate using the STSL; and
communicating with the other device using the STSL if the one or more communications frames contain the request.

11. An apparatus, comprising:
a first communications device to communicate wirelessly with an access point in a centralized wireless network, wherein the first communications device is to:
establish a direct station-to-station link (STSL) with a second communications device in the wireless network by using the payloads of one or more frames communicated between the first and second communications devices through the access point; and
perform, subsequent to establishing the STSL, communications directly between the first and second communications devices.

12. The apparatus of claim 11, wherein the first communications device is to transmit, to the second communications device subsequent to establishing the STSL, an intent to enter a doze mode.

13. The apparatus of claim 12, wherein the first communications device is to wake up from the doze mode at a predetermined time to receive transmissions queued up in the access point for the first communications device.

14. The apparatus of claim 13, wherein the first communications device is to perform STSL communications with the second communications device, responsive to determining that the queued up transmissions contain a request from the second communications device to perform STSL communications.

15. The apparatus of claim 11, wherein the first communications device contains multiple antennas.
